(19) United States
(12) Patent Application Publication
(10) Pub. No.: US 2026/0101150 A1
(43) Pub. Date: Apr. 9, 2026

(54) Audio Enhancement Method using Frequency Band Splitting

(71) Applicant: MEDIATEK INC., Hsinchu City (TW)

(72) Inventors: Jen-Wei Huang, Hsinchu City (TW); Yun-Shao Lin, Hsinchu City (TW); Yiou-Wen Cheng, Hsinchu City (TW); Liang-Che Sun, Hsinchu City (TW); Xin-Wei Shih, Hsinchu City (TW)

(73) Assignee: MEDIATEK INC., Hsinchu City (TW)

(21) Appl. No.: 19/337,868

(22) Filed: Sep. 23, 2025

Related U.S. Application Data
(60) Provisional application No. 63/704,081, filed on Oct. 7, 2024.

(51) Int. Cl. H04S 7/00; H04S 1/00

(52) U.S. Cl. CPC H04S 7/307; H04S 1/007; H04S 2400/15

(57) ABSTRACT

A method for real-time audio enhancement, performed by one or more processors, includes receiving an audio input signal associated with a first channel and a second channel, performing frequency band splitting on the audio input signal to generate a set of first frequency components associated with the first channel and the second channel, and a set of second frequency components associated with the first channel and the second channel, processing the set of second frequency components using an audio enhancement operation to generate a set of enhanced second frequency components, and combining the set of first frequency components with the set of enhanced second frequency components to generate an enhanced audio signal associated with the first channel and the second channel.

### CROSS REFERENCE TO RELATED APPLICATIONS

This application claims the benefit of U.S. Provisional Application No. 63/704,081, filed on Oct. 7, 2024. The content of the application is incorporated herein by reference.

### BACKGROUND

Audio recording devices frequently capture both desired audio subjects (such as a person speaking or singing) and undesired secondary sounds (such as background noise or interference). Conventional audio enhancement methods attempt to isolate and enhance the desired audio subject while suppressing unwanted sounds.

Existing audio enhancement solutions typically process the entire audio signal as a single unit. While such approaches can effectively reduce noise, they often compromise the stereo perception of the original recording. Furthermore, these methods generally require processing the complete audio file, making them unsuitable for real-time applications such as telephony or live recording.

Recent developments in artificial intelligence and machine learning have enabled more sophisticated audio enhancement capabilities. However, these advanced algorithms typically require substantial computational resources and introduce significant latency, limiting their practical application in real-time scenarios. Therefore, there exists a need for an audio enhancement system that can overcome these issues.

### SUMMARY

An embodiment provides a method for real-time audio enhancement performed by one or more processors. The method comprises receiving an audio input signal associated with a first channel and a second channel, performing frequency band splitting on the audio input signal to generate a set of first frequency components associated with the first channel and the second channel, and a set of second frequency components associated with the first channel and the second channel, processing the set of second frequency components using an audio enhancement operation to generate a set of enhanced second frequency components, and combining the set of first frequency components with the set of enhanced second frequency components to generate an enhanced audio signal associated with the first channel and the second channel.

An embodiment provides a device for real-time audio enhancement. The device comprise one or more processors configured to receive an audio input signal associated with a first channel and a second channel, perform frequency band splitting on the audio input signal to generate a set of first frequency components associated with the first channel and the second channel, and a set of second frequency components associated with the first channel and the second channel, process the set of second frequency components using an audio enhancement operation to generate a set of enhanced second frequency components, and combine the set of first frequency components with the set of enhanced second frequency components to generate an enhanced audio signal associated with the first channel and the second channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a scenario of audio enhancement functionality in real-world recording environments.

FIG. 2 illustrates an audio enhancement device according to the embodiments.

FIG. 3 illustrates a detailed view of the audio subject enhancement section of the audio enhancement device of FIG. 2.

FIG. 4 illustrates another audio enhancement device according to the embodiments.

FIG. 5 illustrates a detailed view of the audio subject enhancement section of the audio enhancement device of FIG. 4.

FIG. 6 illustrates the detailed implementation of the audio subject enhancement operation block of FIG. 4.

FIG. 7 illustrates a flow diagram of a method for real-time audio enhancement according to the embodiments.

FIG. 8 illustrates a block diagram of an audio recording device 800 according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

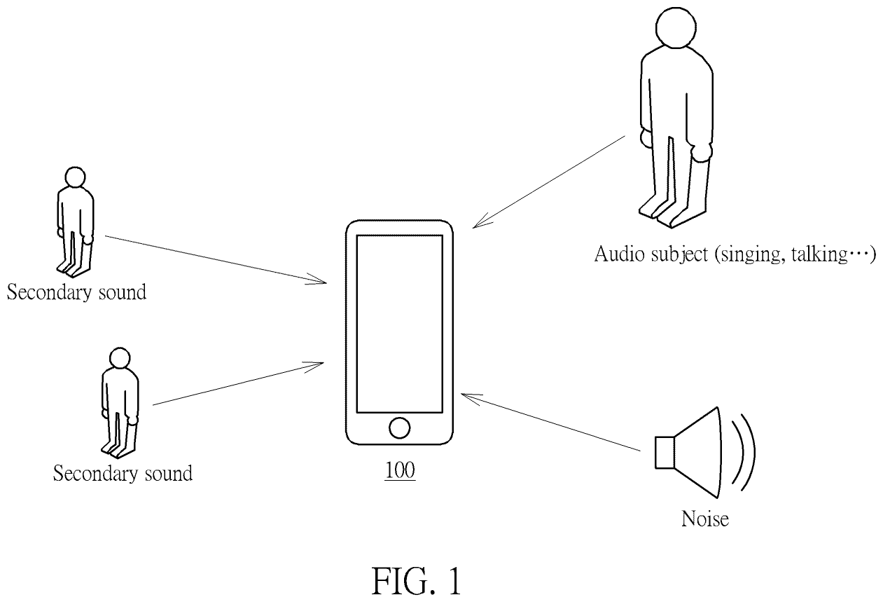

FIG. 1 illustrates a scenario of audio enhancement functionality in real-world recording environments. An audio recording device 100, which may be implemented as a smartphone, professional recording equipment, or any device equipped with audio capture capabilities, functions as the central hub for receiving and processing multiple audio inputs. The recording device 100 incorporates microphone technology to capture incoming audio signals from various sources in the environment.

The recording environment includes multiple sound sources that the audio recording device 100 should process. The primary audio subject, which could be someone singing or talking, represents the main focus of the recording and the sound that needs to be enhanced. This is typically positioned as the central element in the recording setup. Additionally, there are secondary sounds sources present in the environment, represented by two separate figures that produce potentially interfering audio inputs.

Environmental factors also play a role in the scenario, with background noise being a significant consideration in the recording process. This ambient noise, represented by a speaker icon in the diagram, adds another layer of complexity to the audio capture and enhancement process. All of these various audio sources-the main subject, secondary sounds, background noise-converge on the recording device simultaneously.

The practical application of this technology can be illustrated through the example of a concert recording scenario. In this case, the audio recording device 100 may work to preserve and enhance the singer's voice while effectively removing or reducing unwanted elements such as audience singing and environmental noise. The comparison between the original recording and the enhanced version, shown through speaker icons, demonstrates the technology's capability to significantly improve audio quality while maintaining the authenticity of the primary audio subject.

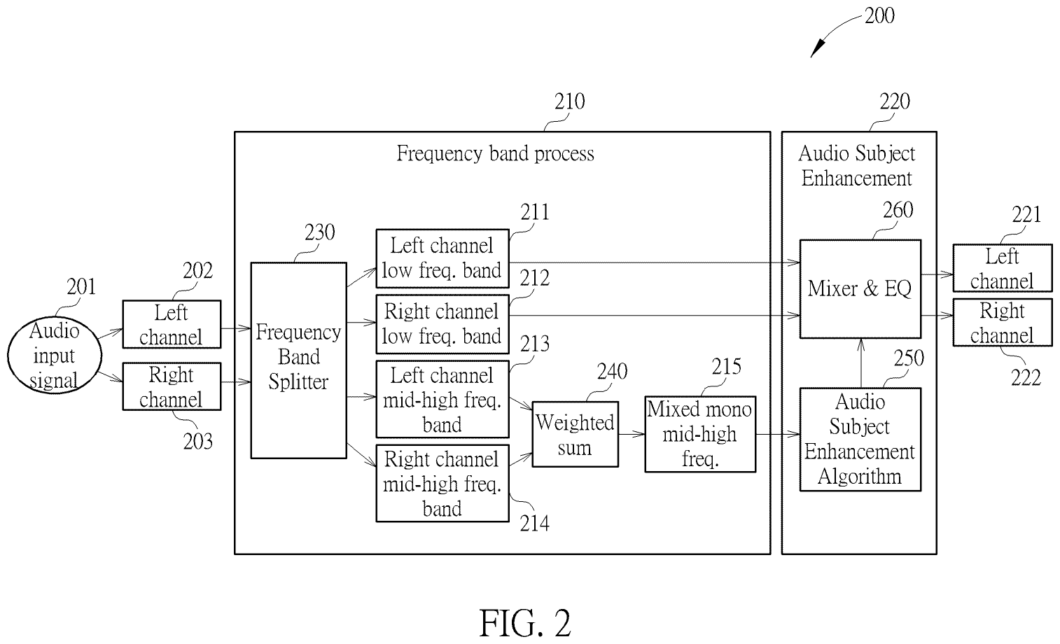

FIG. 2 illustrates an audio enhancement device 200 according to the embodiments of the present invention. The audio enhancement device 200 may be incorporated, partially or fully, into the audio recording device 100. The audio enhancement device 200 receives a stereo audio input signal 201 that includes left channel signal 202 and right channel signal 203. This stereo input represents any audio source that contains spatial information across two channels, such as music recordings, live performances, or voice recordings. This stereo input is then processed through a frequency band splitter 230 within the frequency band process section 210, which separates each channel into different frequency components for specialized processing.

The frequency band splitter 230 divides the audio into four distinct bands: a left channel low frequency band components 211, a right channel low frequency band components 212, a left channel mid-high frequency band components 213, and a right channel mid-high frequency band components 214. This separation is crucial because different frequency ranges may include different types of audio information. The low frequency bands components 211 and 212 typically includes fundamental tones and bass information that are essential for maintaining spatial awareness and are therefore preserved to maintain stereo information and are routed directly to the mixer and equalization (EQ) block 240.

The mid-high frequency bands components 213 and 214, which typically include most of the secondary sounds and noise, undergo additional processing. These components are first being combined through a weighted sum block 260 to generate mixed mono mid-high frequency components 215. The weighted sum process ensures that the combination of these frequencies maintains proper balance and phase relationships. It then feeds into the audio subject enhancement algorithm block 250 within the audio subject enhancement section 220. The audio subject enhancement section 220 includes both the audio enhancement algorithm block 250 and the mixer and EQ block 240 necessary for maintaining stereo perception while improving audio quality through sophisticated signal processing.

The audio subject enhancement algorithm block 250 processes the mixed mono mid-high frequency components 215 using advanced signal processing techniques to perform one or more audio subject enhancement operations to identify and enhance the primary audio subject while reducing unwanted secondary sounds and noise. The processed signal is then output to the mixer and EQ block 240. The mixer and EQ block 240 performs the critical task of recombining all processed signals and outputs enhanced audio signal 221 and 222 associated with left channel components and right channel components respectively, ensuring that the spatial characteristics of the original recording are preserved while the audio quality is improved.

It should be noted that the frequency division between low and mid-high components represents a carefully considered threshold in audio processing. The boundary at approximately 300 Hz marks a significant transition point in the audio spectrum where different characteristics of sound become prominent. Low frequency components, which occupy the spectrum below 300 Hz, contain fundamental tones that contribute significantly to the perception of space, warmth, and depth in audio recordings. These frequencies encompass bass instruments, fundamental vocal harmonics, and room acoustics that are crucial for maintaining natural stereo imaging.

Mid-high frequency components, occupying the spectrum above 300 Hz, carry different but equally important acoustic information. This range includes most of the harmonic content of musical instruments, vocal articulation, and many of the secondary sounds and environmental noises that often require enhancement or reduction. The 300 Hz threshold was selected based on extensive analysis of human auditory perception and the typical distribution of musical and vocal content across the frequency spectrum.

This frequency division point at 300 Hz aligns with important psychoacoustic principles. Below this frequency, human hearing relies more on phase relationships and timing differences between ears for spatial localization, making these frequencies crucial for maintaining stereo perception. Above 300 Hz, the ear increasingly uses intensity differences for spatial localization, allowing for more aggressive processing without compromising the overall stereo image.

The selection of 300 Hz as the approximate division point also considers practical implementation aspects in audio processing systems. This frequency provides an optimal balance between maintaining sufficient low-frequency content for preserving spatial information while allowing effective enhancement of the mid-high frequency range where most unwanted sounds typically occur. This division enables the system to apply different processing strategies to each range, optimizing the enhancement of desired audio elements while preserving the natural characteristics of the recording.

Moreover, this frequency threshold acknowledges the different behaviors of sound in these ranges. Low frequencies tend to be more omnidirectional and less affected by room acoustics, while frequencies above 300 Hz become increasingly directional and more susceptible to environmental effects. This natural behavior of sound waves influences how each frequency range contributes to the overall audio experience and guides the processing approach for each band.

The entire process is designed to enhance the primary audio subject while preserving the spatial characteristics of the original stereo recording, effectively managing both the enhancement of desired audio content and the maintenance of stereo sound quality in the final output. This careful balance between enhancement and preservation ensures that the processed audio maintains its natural stereo image while achieving superior clarity and focus on the primary audio subject.

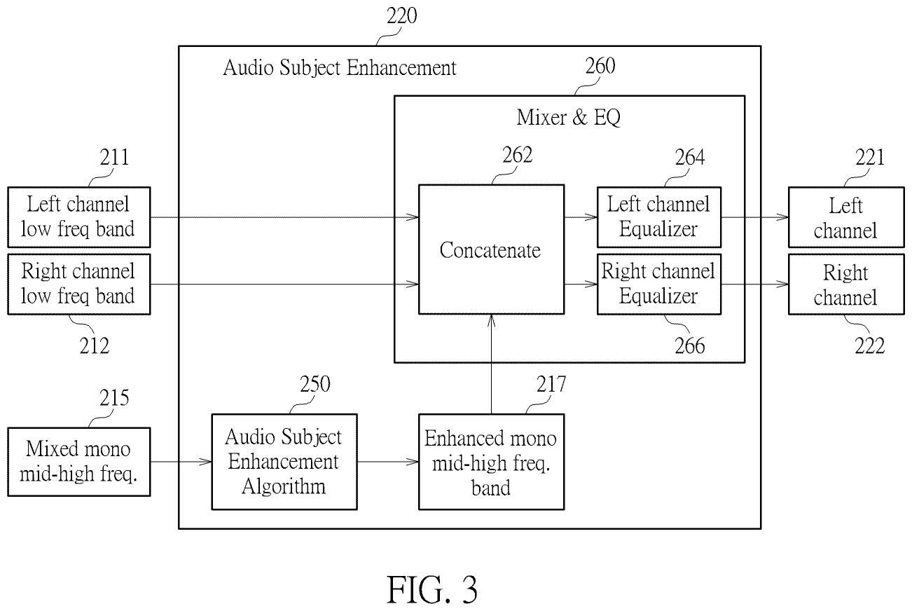

FIG. 3 illustrates a detailed view of the audio subject enhancement section 220 of the audio enhancement device 200 according to the embodiments of the present invention. The section receives three primary inputs: the left channel low frequency band components 211, the right channel low frequency band components 212, and the mixed mono mid-high frequency components 215 from the frequency band process section.

The mixed mono mid-high frequency components 215 are first processed through the audio subject enhancement algorithm block 250, which applies specialized enhancement techniques to produce enhanced mono mid-high frequency components 217. This enhanced signal represents the processed version of the mid and high frequency content where most secondary sounds and noise have been addressed.

Within the mixer and EQ block 260, the concatenate block 262 combines the enhanced mono mid-high frequency components 217 with the unprocessed low frequency band components 211 and 212 associated with the left channel and the right channel respectively. The concatenated signals then pass through dedicated equalization stages: the left channel equalizer 264 and the right channel equalizer 266. These equalizers can maintain proper frequency balance and ensuring the enhanced audio maintains natural characteristics similar to the original recording.

The final output of the audio subject enhancement section 220 includes the enhanced audio signals 221 and 222 associated with the left channel and the right channel respectively, which represent the fully processed stereo audio signal. The enhanced audio signals 221 and 222 preserves the spatial characteristics of the original stereo recording while providing enhanced clarity and focus on the primary audio subject through the selective processing of different frequency bands.

The entire signal chain within the audio subject enhancement section 220 is designed to carefully balance the enhancement of desired audio content with the preservation of the original stereo image, ensuring that the final output maintains both improved audio quality and natural stereo characteristics.

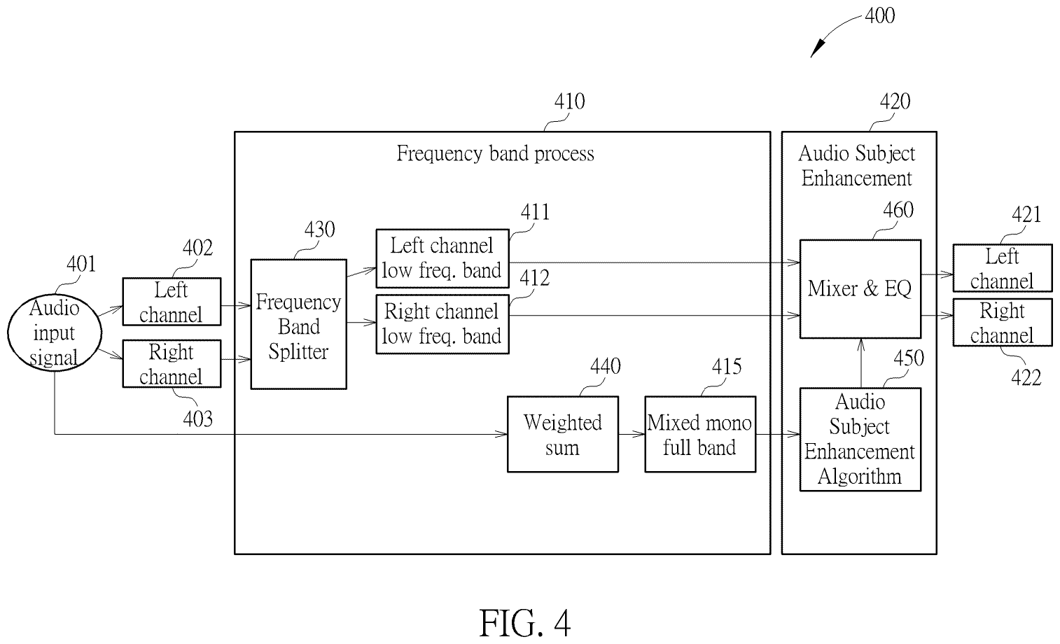

FIG. 4 illustrates an audio enhancement device 400 according to the embodiments of the present invention. The audio enhancement device 400 may be incorporated, partially or fully, into the audio recording device 100. The audio enhancement device 400 receives an audio input signal 401 that includes left channel 402 and right channel 403. This embodiment is specifically designed for audio subject enhancement operations that require full-frequency band information for their computations, such as advanced AI-based processing systems or neural networks that analyze the complete audio spectrum to make intelligent enhancement decisions.

The signal path diverges into two parallel processes within the frequency band process section 410. The first path routes the stereo signal through a frequency band splitter 430, which extracts the low frequency components: left channel low frequency band components 411 and right channel low frequency band components 412. These low frequency components 411 and 412 are preserved to maintain stereo information and are routed directly to the mixer and EQ block 460 within the audio subject enhancement section 420. This preservation is crucial because low frequency components contain fundamental spatial information that contributes significantly to the listener's perception of the stereo image.

The second path processes the full stereo signal through a weighted sum block 440, which combines the components associated with the left channel and the right channel to generate mixed mono full band components 415. This mono signal includes the complete frequency spectrum needed by modern audio enhancement operations, such as those based on AI or neural networks, which may require full-band information for optimal performance. The weighted sum process ensures that the mono signal maintains proper phase relationships and energy distribution across the frequency spectrum, preventing any loss of critical audio information during the conversion from stereo to mono.

Within the audio subject enhancement section 420, the mixed mono full band components 415 is processed by the audio subject enhancement algorithm block 450, which applies sophisticated enhancement techniques or operations to the full-frequency content. These techniques may include advanced signal processing methods such as spectral analysis, machine learning-based feature extraction, and intelligent noise reduction. The enhanced signal is then fed to the mixer and EQ block 460, where it is combined with the preserved stereo low frequency components 411 and 412.

The mixer and EQ block 460 performs the critical task of recombining the enhanced mono signal with the preserved stereo low frequency components. This block carefully balances the relative levels and frequency responses to ensure a natural transition between the processed and unprocessed portions of the spectrum. The block outputs the enhanced audio signals 421 and 422 associated with the left channel and the right channel respectively. This alternative architecture ensures that the enhancement operation has access to full-frequency information while still maintaining the stereo perception through the preservation and proper mixing of the low frequency components.

This approach represents a significant advancement over traditional enhancement methods by allowing sophisticated full-band processing while preserving the spatial characteristics that are crucial for an immersive listening experience. The architecture effectively balances the competing demands of advanced signal processing and natural stereo reproduction.

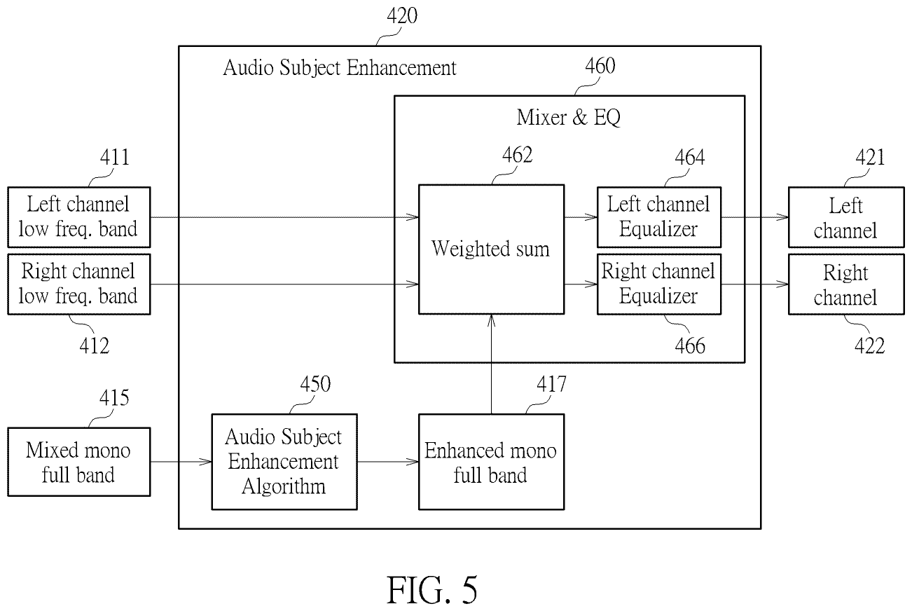

FIG. 5 illustrates a detailed view of the audio subject enhancement section 420 of the audio enhancement device 400. The section processes three input signals: the left channel low frequency band components 411, the right channel low frequency band components 412, and the mixed mono full band components 415 that includes the complete frequency spectrum.

The mixed mono full band components 415 are first processed through the audio subject enhancement algorithm block 450, which applies advanced enhancement techniques or operations to produce enhanced mono full band components 417. This signal contains the enhanced version of the complete frequency spectrum, where the primary audio subject has been enhanced while unwanted elements have been reduced or removed.

Within the mixer and EQ section, the weighted sum block 462 plays a crucial role in combining the enhanced mono full band components 417 with the preserved low frequency band components 411 and 412. For audio enhancement operations that utilize full-frequency information, the original stereo low frequency components are mixed with the enhanced mono low frequency components using a weighted sum approach to maintain proper balance and spatial characteristics.

The combined signals then pass through dedicated equalization stages: the left channel equalizer 464 and the right channel equalizer 466. These equalizers can ensure that the final output maintains a natural frequency response while preserving the stereo image of the original recording. The equalizers can be adjusted to match the frequency characteristics of the original audio, helping to maintain a consistent and natural sound.

The output of the audio subject enhancement section 420 includes the enhanced audio signals 221 and 222 associated with the left channel and the right channel respectively, which represent the fully processed stereo audio signal. This architecture demonstrates how full-band processing can be effectively combined with stereo preservation techniques to achieve both enhanced audio quality and maintained spatial characteristics in the final output.

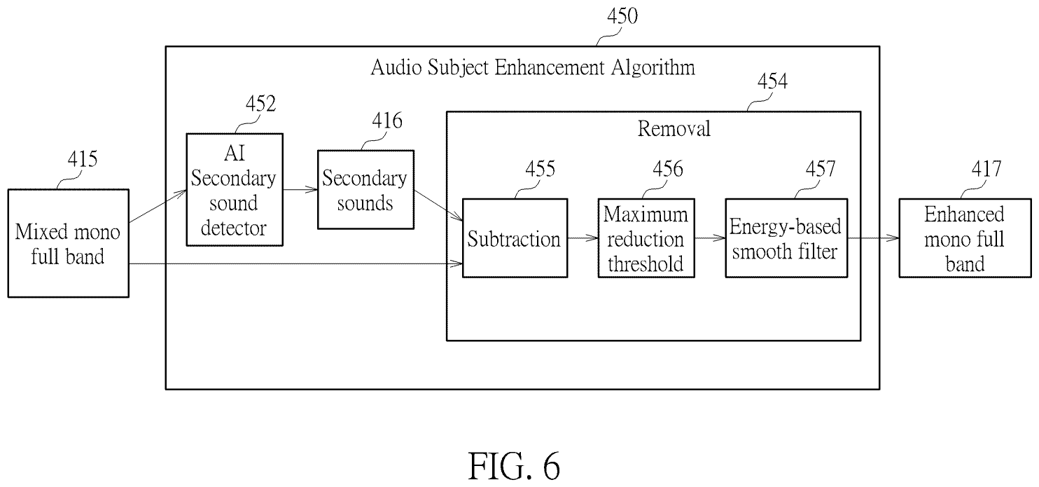

FIG. 6 illustrates the detailed implementation of the audio subject enhancement algorithm block 450 according to the embodiments of the present invention. This block processes the mixed mono full band signal 415 through a series of sophisticated processing stages to produce the enhanced mono full band output 417. The architecture represents an advanced approach to audio enhancement that combines artificial intelligence with traditional signal processing techniques.

The first stage employs an AI secondary sound detector 452 that analyzes the input signal to identify and isolate secondary sounds and noise, within the audio stream. This AI-based detection system uses advanced pattern recognition and machine learning techniques to distinguish between primary audio content and unwanted secondary sounds and noise. The AI secondary sound detector 452 outputs identified secondary sound components 416, which represent the unwanted audio elements that need to be removed or reduced from the original signal.

The removal section 454 includes three sequential processing blocks that work together to effectively eliminate the detected secondary sounds and noise while preserving the quality of the primary audio subject. The first block is the subtraction block 455, which performs a precise spectral subtraction process to remove the identified secondary sound components 416 from the original signal. This subtraction must be carefully calibrated to maintain the integrity of the primary audio content while effectively removing unwanted elements.

To prevent over-processing and maintain natural sound characteristics, the signal then passes through a maximum reduction threshold block 456. This critical component ensures that the level of reduction applied to any portion of the signal does not exceed a predetermined threshold, preventing artifacts or unnatural sound qualities that could result from excessive processing. The threshold is carefully calibrated to balance effective noise reduction with natural sound preservation.

The third stage in the removal chain is the energy-based smooth filter 457, which employs sophisticated filtering techniques to eliminate any potential discontinuities or artifacts that might have been introduced during the subtraction process. This filter analyzes the energy distribution across the frequency spectrum to ensure smooth transitions and natural sound quality in the processed audio.

The processed signal emerges as the enhanced mono full band output 417, which represents the original audio with secondary sounds and noise effectively reduced while maintaining the integrity and naturalness of the primary audio subject. The enhanced output maintains the full frequency spectrum necessary for high-quality audio reproduction while eliminating unwanted elements that could detract from the listening experience.

The entire operation reflects a careful balance between aggressive noise reduction and the preservation of natural sound qualities, ensuring that the enhanced output maintains high fidelity while effectively removing unwanted audio elements. This sophisticated processing chain demonstrates the power of combining artificial intelligence with traditional signal processing techniques to achieve superior audio enhancement results.

The advantage of this implementation lies in its intelligent and systematic approach to audio enhancement. By combining AI-based detection with carefully controlled removal processes, the system can achieve more precise and natural-sounding results compared to traditional methods. The three-stage removal process ensures that noise reduction is performed without introducing artifacts or compromising the quality of the primary audio, while the energy-based smoothing maintains the natural flow and continuity of the sound. This makes the system particularly effective for real-world applications where maintaining audio quality is as important as removing unwanted noise.

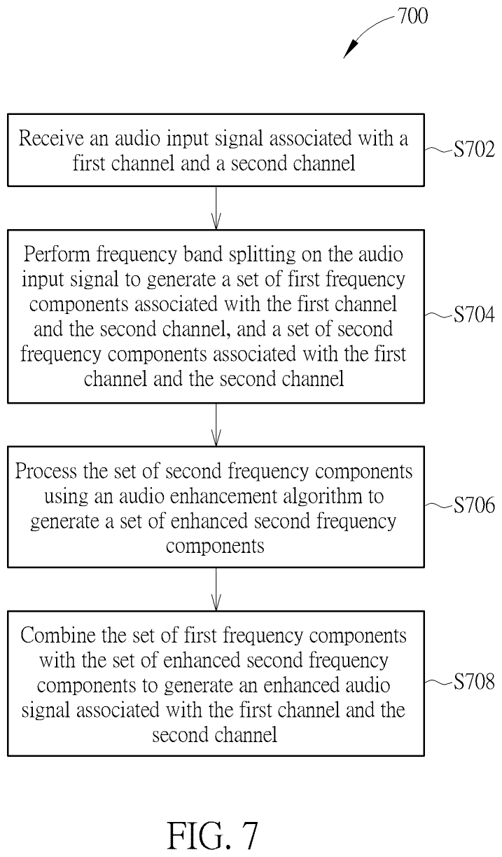

FIG. 7 illustrates a flow diagram of a method 700 for real-time audio enhancement according to the embodiments of the present invention. The method 700 corresponds to the above description which comprises a systematic approach to processing stereo audio signals while maintaining spatial characteristics and enhancing audio quality. The method 700 includes the following steps:

S702: Receive an audio input signal associated with a first channel and a second channel;

S704: Perform frequency band splitting on the audio input signal to generate a set of first frequency components associated with the first channel and the second channel, and a set of second frequency components associated with the first channel and the second channel;

S706: Process the set of second frequency components using an audio enhancement operation to generate a set of enhanced second frequency components; and S708: Combine the set of first frequency components with the set of enhanced second frequency components to generate an enhanced audio signal associated with the first channel and the second channel.

The first step (S702) involves receiving an audio input signal associated with a first channel and a second channel. This stereo input signal represents the original audio content that requires enhancement, such as a music recording, live performance, or any other stereo audio source. The two channels typically correspond to left and right channels in a conventional stereo setup, containing spatial information that creates the stereo image.

In the next step (S704), the method performs frequency band splitting on the audio input signal. This critical step generates two distinct sets of frequency components: a set of first frequency components and a set of second frequency components, both associated with the first channel and the second channel. The first frequency components typically represent the low frequency content, which contains fundamental tones and crucial spatial information. The second frequency components comprise the mid-to-high frequency range, where most secondary sounds and noise typically reside. In some embodiments, the second frequency components may include full band frequency relevant to the described audio processing.

The third step (S706) focuses on processing the set of second frequency components using an audio enhancement operation to generate a set of enhanced second frequency components. This processing step applies sophisticated signal analysis and enhancement techniques to identify and reduce unwanted secondary sounds and noise while preserving and enhancing the primary audio content. The enhancement operation may employ various techniques or operations such as AI-based detection, spectral subtraction, and adaptive filtering to achieve optimal results.

In the final step (S708), the method combines the set of first frequency components with the set of enhanced second frequency components to generate an enhanced audio signal associated with the first channel and the second channel. This combination process carefully balances the preserved low frequency spatial information with the enhanced mid-to-high frequency content, ensuring that the final output maintains natural stereo imaging while benefiting from the enhancement processing.

The method represents a sophisticated approach to real-time audio enhancement that addresses the dual challenges of maintaining stereo perception and achieving effective audio enhancement. By processing different frequency bands separately and recombining them intelligently, the method ensures that spatial information is preserved while allowing for effective enhancement of the audio content where it's most needed.

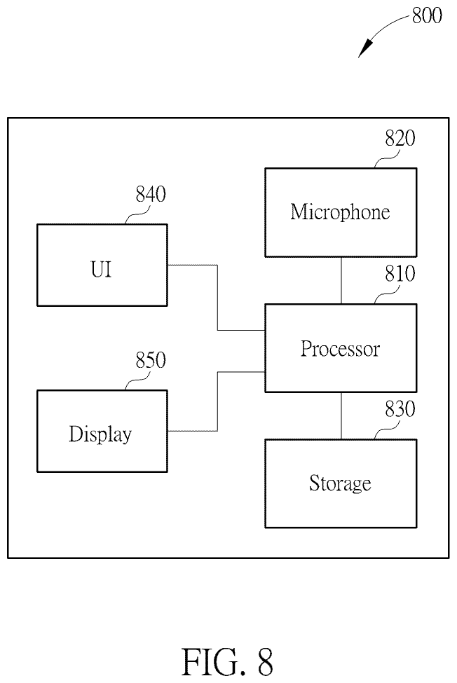

FIG. 8 illustrates a block diagram of an audio recording device 800 according to the embodiments of the present invention. The device comprises several key components interconnected to enable audio capture, processing, and user interaction. The audio recording device 800 includes a processor 810 that serves as the central processing unit, coordinating operations between all other components and executing the audio enhancement operations. The processor 800 can handles multiple tasks simultaneously: it can manage the real-time audio signal processing, execute the enhancement operations, coordinate data flow between components, and respond to user inputs. The processor 800 is able to handle the complex calculations required for frequency band splitting, AI-based detection, and signal enhancement while maintaining real-time performance.

The processor 810 couples to a microphone 820, which captures the audio from the environment and converts it to audio input signals. The microphone 820 represents the primary input interface for the device. It can be designed to capture stereo audio from the environment with high fidelity and convert them into analog or digital signals that the processor 800 can manipulate. The microphone 820 may include advanced features such as noise cancellation, directional pickup patterns, and high-quality analog-to-digital conversion to ensure optimal audio capture.

The audio recording device 800 also includes a storage 830 coupled to the processor 810, which stores both the recorded audio data and the processing operations. This storage may include both volatile and non-volatile memory to handle both temporary processing needs and long-term data storage. For example, the storage 830 may implements a combination of random access memory (RAM) for real-time processing needs and flash memory for permanent data retention.

For user interaction, the device features a user interface (UI) 840 that allows users to control recording settings and enhancement parameters. The UI 840 provides access to various recording settings, enhancement parameters, and processing options. The UI 840 can be designed to be intuitive while offering advanced controls for professional users who need fine-tuned adjustment of enhancement parameters. In addition, the UI may include physical buttons, touch-sensitive controls, or other input mechanisms depending on the specific implementation.

A display 850 provides visual feedback and status information to the user. The display 850 might be implemented as an LCD screen, LED array, or other visual output device depending on the specific requirements of the application. Both the UI 840 and display 850 are coupled to the processor 810, enabling interaction between the user and the audio recording device 800.

This hardware architecture specifically supports the sophisticated audio enhancement capabilities described in previous embodiments. It provides the necessary computational power for real-time frequency band splitting and enhancement while maintaining responsive user control and efficient data management. The design demonstrates a careful balance between processing capability, user accessibility, and practical functionality in real-world recording scenarios.

The invention presents significant advancements in audio enhancement technology through its innovative approach to real-time signal processing and stereo preservation. At its core, the technology enables the implementation of sophisticated non-real-time operations in real-time applications, a breakthrough that has been challenging to achieve in traditional audio processing systems. This is accomplished through an innovative dual-path processing architecture that significantly reduces processing latency while maintaining high-quality enhancement capabilities. The system's ability to operate in real-time makes it particularly valuable for applications such as live telephony, concert recordings, and broadcast scenarios where immediate processing is crucial.

A key strength of the invention lies in its ability to preserve the spatial characteristics of stereo recordings while performing enhancement operations. The system carefully manages frequency bands, particularly preserving low frequency stereo information that is crucial for spatial perception. This preservation is achieved through sophisticated processing techniques that ensure the enhancement process does not compromise the natural stereo image of the original recording, resulting in improved audio quality that maintains its original spatial characteristics.

The technology incorporates intelligent processing approaches that set it apart from conventional enhancement methods. By utilizing AI-based detection systems, the invention can precisely identify and isolate secondary sounds for removal. The sophisticated three-stage removal process, including maximum reduction thresholds, ensures that enhancement is performed without over-processing the audio signal. This careful balance maintains the natural qualities of the sound while effectively removing unwanted elements, a crucial aspect for maintaining audio fidelity.

The flexible architecture of the invention represents another significant advantage. The system can accommodate both traditional and AI-based enhancement operations, supporting full-frequency band processing when needed. This adaptability makes it suitable for various types of audio content and allows implementation across different recording devices and scenarios. The architecture's versatility ensures that it can meet diverse audio enhancement needs while maintaining consistent performance.

Quality control mechanisms are integrated throughout the processing chain to ensure optimal results. The system employs energy-based smooth filtering to prevent artifacts, uses weighted sum approaches for balanced signal combination, and features dedicated equalization stages for maintaining natural frequency response. These precise controls over the enhancement process prevent degradation of the audio signal while ensuring effective enhancement. This comprehensive approach to quality control demonstrates how the invention successfully combines advanced processing capabilities with practical usability in real-world applications.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for real-time audio enhancement, performed by one or more processors, comprising:
receiving an audio input signal associated with a first channel and a second channel;
performing frequency band splitting on the audio input signal to generate a set of first frequency components associated with the first channel and the second channel, and a set of second frequency components associated with the first channel and the second channel;
processing the set of second frequency components using an audio enhancement operation to generate a set of enhanced second frequency components; and
combining the set of first frequency components with the set of enhanced second frequency components to generate an enhanced audio signal associated with the first channel and the second channel.

2. The method of claim 1, wherein processing the set of second frequency components using the audio enhancement operation comprises:
combining the set of second frequency components associated with the first channel with the set of second frequency components associated with the second channel using a weighted sum to generate a set of mixed mono second frequency components; and
applying the audio enhancement operation to the set of mixed mono second frequency components to generate the set of enhanced second frequency components.

3. The method of claim 2, wherein applying the audio enhancement operation to the set of mixed mono second frequency components comprises:
detecting a set of secondary sound components from the set of mixed mono second frequency components; and
reducing the set of secondary sound components with a maximum reduction threshold.

4. The method of claim 3, wherein reducing the set of secondary sound components comprises:
subtracting the set of secondary sound components from the set of mixed mono second frequency components to generate a set of subtracted mixed mono second frequency components; and
applying an energy-based smooth filter to the set of subtracted mixed mono second frequency components.

5. The method of claim 1, wherein combining the set of first frequency components with the set of enhanced second frequency components comprises adjusting equalization (EQ) of the first channel and the second channels according to the audio input signal.

6. The method of claim 1, further comprising outputting, by the processor, the enhanced audio signal associated with the first channel and the second channel.

7. The method of claim 1, wherein the set of first frequency components comprises low frequency components with frequency approximately below 300 Hz.

8. The method of claim 1, wherein the set of second frequency components comprises higher-frequency components with frequency approximately above 300 Hz.

9. The method of claim 1, wherein the set of second frequency components comprises approximately full-band frequency associated with the audio input signal.

10. A device for real-time audio enhancement, comprising one or more processors configured to:
receive an audio input signal associated with a first channel and a second channel;
perform frequency band splitting on the audio input signal to generate a set of first frequency components associated with the first channel and the second channel, and a set of second frequency components associated with the first channel and the second channel;
process the set of second frequency components using an audio enhancement operation to generate a set of enhanced second frequency components; and
combine the set of first frequency components with the set of enhanced second frequency components to generate an enhanced audio signal associated with the first channel and the second channel.

11. The device of claim 10, wherein the one or more processors are further configured to:
combine the set of second frequency components associated with the first channel with the set of second frequency components associated with the second channel using a weighted sum to generate a set of mixed mono second frequency components; and
apply the audio enhancement operation to the set of mixed mono second frequency components to generate the set of enhanced second frequency components.

12. The device of claim 11, wherein the one or more processors are further configured to:
detect a set of secondary sound components from the set of mixed mono second frequency components; and
reduce the set of secondary sound components with a maximum reduction threshold.

13. The device of claim 12, wherein the one or more processors are further configured to:
subtract the set of secondary sound components from the set of mixed mono second frequency components to generate a set of subtracted mixed mono second frequency components; and
apply an energy-based smooth filter to the set of subtracted mixed mono second frequency components.

14. The device of claim 10, wherein to combine the set of first frequency components with the set of enhanced second frequency components, the processor is configured to adjust equalization (EQ) of the first channel and the second channel according to the audio input signal.

15. The device of claim 10, wherein the one or more processors are further configured to output the enhanced audio signal associated with the first channel and the second channel.

16. The device of claim 10, wherein the set of first frequency components comprises low frequency components with frequency approximately below 300 Hz.

17. The device of claim 10, wherein the set of second frequency components comprises higher-frequency components with frequency approximately above 300 Hz.

18. The device of claim 10, wherein the set of second frequency components comprises approximately full-band frequency associated with the audio input signal.
